(19) United States
(12) Patent Application Publication
(10) Pub. No.: US 2013/0031825 A1
(43) Pub. Date: Feb. 7, 2013

(54) CHAMBERED BED BUG TRAP STRIP

(71) Applicant: Devi Dass, San Francisco, CA (US)

(72) Inventor: Devi Dass, San Francisco, CA (US)

(21) Appl. No.: 13/166,604

(22) Filed: Aug. 2, 2011

(51) Int. Cl. A01M 1/14; A01M 1/10

(52) U.S. Cl. 43/114; 43/123

(57) ABSTRACT

The subject invention is a bed bug trap strip comprised of a top flat strip of durable material which is affixed to the top of hollow chambers. The invention incorporates a base strip upon the top of which base strip are mounted multiple hollow trap chambers, each chamber is mounted with a gap between them to afford easy access by the bed bugs, with barriers to prevent exit of the bed bugs through the gaps. The chamber gaps are of sufficient width to allow multiple bed bugs to easily crawl between them and to enter the trap chamber through openings on either end of the chambers where the adhesive surface on the base strip entraps the bed bugs for later disposal. The bottom of the base strip has an adhesive strip affixed which allows the user to quickly attach the trap strip to the desired surface area.

### CROSS-REFERENCE TO RELATED APPLICATIONS

N/A

### STATEMENT REGARDING FEDERALLY SPONSORED RESEARCH

N/A

### THE NAMES OF THE PARTIES TO A JOINT RESEARCH AGREEMENT

N/A

### INCORPORATION-BY-REFERENCE OF MATERIAL SUBMITTED ON A COMPACT DISC

N/A

### BACKGROUND OF THE INVENTION

(1) Field of the Invention

The field of the invention is that of insect eradication or capture, in particular: bed bugs.

(2) Description of Related Art Including Information Disclosed Under 37 CFR 1.97 and 1.98

U.S. Utility Pat. No. 1,132,789, invented by Canio Mecco, issued on Mar. 23, 1915, “Bug Trap For Beds”, discloses an open weave basket-shaped trap to be positioned under the bed and attached to the bed frames. This invention is for a collector of the bugs, which can then be destroyed in an unspecified way.

U.S. Utility Pat. No. 1,108.870, invented by Emmer B. Arnold, issued Aug. 24, 1914, “TRAP”, which discloses a trapping arrangement with a sheet of material to entrap the bugs and which is inserted into a frame for placement under the bed.

U.S. Utility Pat. No. 1,439,874, invented by J. P. Dillin, issued Dec. 26, 1922, “Insect Trap”, which discloses two boards hinged together, placed one on top of the other and designed to rock open and closed and to trap and crush any bugs taking refuge between the two boards.

U.S. Utility Pat. No. 1,261,842, invented by Wilhelm Muller, issued Apr. 9, 1918, “Bug-Trap”, which discloses something similar to corrugated cardboard, which is used to trap the bed bugs for later disposal if they are still in the trap.

### BRIEF SUMMARY OF THE INVENTION

The present invention is a substantial improvement over the prior art and takes advantage of modern technology. The invention consists of a base strip 1 upon which are mounted multiple trap chambers 2, each with chamber openings 5 on either end, and each chamber separated by a chamber gap 3, which affords the bed bug access to the chamber openings 5. Each chamber gap 3 has an entry barrier 6, which prevents the bed bug from crawling through the chamber gap 3 rather than into the chamber opening 5. When the bed bugs enter the chamber openings 5, they walk upon the adhesive surface of the base strip 1 of the trap chambers 2 and are unable to move thereafter.

### BRIEF DESCRIPTION OF THE SEVERAL VIEWS OF THE DRAWINGS

FIG. 1 shows a top view of the trap strip with chambers

FIG. 2 shows a side view of the trap strip with chambers and adhesive strip

FIG. 3 shows an end view of the trap strip with chambers and adhesive strip

### DETAILED DESCRIPTION OF THE INVENTION

### Reference Numerals

1—base strip the adhesive strip which forms the base for the trap chambers 2 that are used to trap the crawling bed bugs who encounter the base strip 1, the strip will typically be made of plastic or other durable material with an adhesive surface capable of capturing any bedbug that places an extremity or other portion of its body in contact with the adhesive surface
2—trap chamber where the adhesive is found to capture the bed bugs when they adhere to the base strip 1 when they crawl into one of the chamber openings 5 in the trap chamber 2 which has access openings on either side and is mounted on the adhesive base strip 1
3—chamber gap is the gap between the trap chambers 2 mounted on the base strip 1 which allows access to the chamber openings 5 in the mounted trap chambers 2 where the crawling insects will then encounter the chamber adhesive. Each chamber gap 3 has an entry barrier 6, which prevents the bed bug from crawling through the chamber gap 3 rather than into the chamber opening 5.
4—adhesive strip is a strip or other form of adhesive without a strip, affixed to the underside of the trap strip 2, which has adhesive on its top side to affix to the underside of the base strip 1 and adhesive on its underside to affix the base strip 1 to the target area, such as a bed rail or post, baseboard, wall or other area where the user wants to capture and kill bed bugs
5—chamber opening is found on either end of the trap chamber 2 which affords entry for the crawling insects and bed bugs to enter the mounted trap chamber 2 where the crawling insects will then encounter the capturing adhesive
6—entry barrier in each chamber gap 3, which is situated from the leading edge of one trap chamber opening 5 to the trailing edge of the adjacent trap chamber 2 and its trap chamber opening 5, that prevents the bed bug from crawling through the chamber gap 3 without entering the trap chamber opening 5.
7—top handling strip which is the strip of non-adhesive material which is mounted on top of the trap chambers 2 so that the invention can be conveniently handled by the user without encountering any adhesive. The top handling strip 7 is affixed to the top of all the trap chambers 2 mounted on the base strip 1 for strength and stability of the invention and to keep the proper positioning of the trap chambers 2, and the chamber gaps 3 and entry barriers 6

### DETAILED DESCRIPTION OF THE DRAWINGS

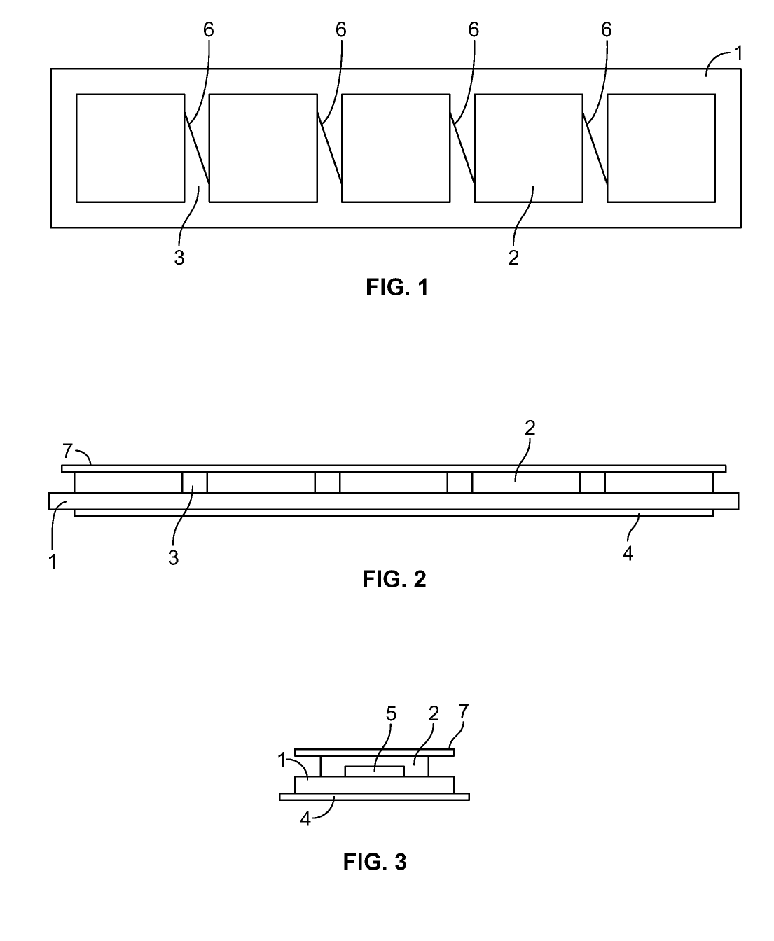

FIG. 1 shows a top view of the adhesive base strip 1 (without the top handling strip 7 for ease of reference) with the trap chambers 2 mounted on the base strip 1 and the chamber gaps 3 between the trap chambers 2. The entry barriers 6 are shown in each chamber gap 3, which is situated from the leading edge of one chamber opening 5 to the trailing edge of the adjacent chamber 2 and its chamber opening 5, that prevents the bed bug from crawling through the chamber gap 3 without entering the chamber opening 5. The trap chambers 2 are each of sufficient size to accommodate the entry of multiple bed bugs, and for these bed bugs to be captured by the base strip adhesive 1 and to remain trapped in place while still leaving ample room for the entry of many more bed bugs. In this way, the base strip 1 can remain in place for an extended period before disposal and/or replacement is required.

FIG. 2 shows a side view of the invention, with the top handling strip 7, and the adhesive base strip 1 with trap chambers 2 and adhesive strip 4 affixed to the underside of the base strip 1, which has adhesive on the top side of the adhesive strip 4 to affix to the underside of the base strip 1 and adhesive on the adhesive strip 4 underside to affix the base strip 1 to the desired area, which can be any suitable surface, such as a wall, a bed rail or a bed post, where the user wants to capture and kill bed bugs. The chamber gaps 3 are shown, but the gap barriers 6 are not shown.

FIG. 3 shows an end view of the invention, with the top handling strip 7, and the adhesive base strip 1 with trap chamber 2 and adhesive strip 4 and the trap chamber opening 5. The base strip 1 will typically be made of plastic or other durable material with adhesive on the top side to afford ease of access by the bed bugs or other crawling insects into the trap chamber 2 in which the base strip 1 with adhesive forms the floor of each trap chamber 2. The depicted chamber opening 5 is found on either end of the trap chamber 2 which is in sufficient height and width to afford easy entry for the crawling insects and bed bugs to enter the mounted trap chamber 2 where the crawling insects will then be captured by their sticking to the adhesive surface.

### DETAILED DESCRIPTION OF THE INVENTION AND PREFERRED EMBODIMENT

The subject invention is extremely useful to the user of the invention because the invention can be easily carried with the user on travels in which the user will be using publicly available beds, such as hotels and motels and other accommodations. The user can then affix the bed bug trap strip before using the public bed with the comfort of knowing that something has been done to trap the bed bugs, if any.

Since the invention is simply several strips of materials with mounted trap chambers 2 and the materials of which it is comprised are lightweight and durable, the bed bug trap strip can easily be carried and used in strange places while traveling.

The adhesive base strip 1 forms the base for the trap chambers 2 and the adhesive property of the adhesive base strip 1 readily adheres to the crawling insect and affixes the insect to the adhesive base strip 1, to effectively trap the crawling bed bugs who encounter the base strip 1, the base strip 1 will typically be made of plastic or other durable material with adhesive on the top side of the base strip 1 to capture the crawling bed bugs.

Each hollow trap chamber 2 is mounted on the base strip 1 with a chamber gap 3 between each of the trap chambers 2. The chamber gap 3 has an entry barrier 6, which is situated from the leading edge of one chamber opening 5 to the trailing edge of the adjacent chamber 2 and its chamber opening 5, that prevents the bed bug from crawling through the chamber gap 3 without entering the chamber opening 5. The chamber gaps 3 are of sufficient width to allow multiple bed bugs to easily crawl between them from either side of the base strip 1, and to enter the trap chamber 2 where the adhesive on the base strip 1 will capture the bed bugs once they crawl into one of the chamber openings 5 on either end of the trap chambers 2.

The base strip 1 uses modern pressure sensitive adhesive technology to contribute to the usefulness and ease of use of the invention. An adhesive strip 4 is a strip affixed to the underside of the base strip 1, which has adhesive on the top side of the adhesive strip 4 to affix to the underside of the base strip 1 and adhesive on the adhesive strip 4 underside to affix the base strip 1 to the desired potentially infested area, which can be any suitable surface, such as a wall, a bed rail or a bed post, baseboard or wall, where ever the user wants to capture bed bugs. The adhesive strip 4 could be comprised of double-backed tape in which a cover material is removed to expose the adhesive for use, or similar mode of adhesive.

1. I claim an insect trap strip comprised of:
a base strip of durable material having an adhesive flat surface on its top and a non-adhesive flat surface on the bottom surface of said base strip, the adhesive on said top adhesive flat surface being strong enough to capture and hold bed bugs or other crawling insects, and said base strip having ample width and length for mounting multiple in-line hollow chambers on the top adhesive flat surface of said base strip;
said multiple in-line hollow chambers are each separated by a chamber gap sufficient to afford access by multiple bed bugs and other crawling insects into the chamber openings on either end of each said multiple in-line hollow chamber;
an entry barrier in each said chamber gap which is situated from the leading edge of each said in-line hollow chamber opening to the trailing edge of the adjacent said in-line hollow chamber opening, said entry barrier being of sufficient height to prevent a bed bug or other crawling insect from crawling under or over said entry barrier, or from crawling through said chamber gap without entering said chamber opening;
a top handling strip of durable material being of sufficient length and width to cover all said in-line hollow chambers, and being fixedly attached to the top of said in-line hollow chambers; and,
adhesive means suitable for affixing said non-adhesive flat surface on the bottom of said base strip to the surface of a target capture area.

2. The insect trap strip according to claim 1, wherein said adhesive means is in the form of a strip of two-sided adhesive material, initially covered with material over the adhesive bottom of said adhesive strip wherein said material preserves the adhesive until said material is removed to expose said bottom side adhesive surface for use.
